(19) United States
(12) Patent Application Publication
(10) Pub. No.: US 2004/0024661 A1
(43) Pub. Date: Feb. 5, 2004

(54) Systems and methods for inventory management

(75) Inventors: Thomas M. Freel, New Carlisle, IN (US); Ganesh Vaidyanathan, Granger, IN (US); Andrew J. Grile, Berrien Springs, MI (US); Thomas M. Barcome, Mishawaka, IN (US); Rodolfo W. Paredes, Mishawaka, IN (US); Marjorie J. Pethick, Niles, MI (US); Girish Shirhatti, Granger, IN (US); David G. Kulakowski, Granger, IN (US); Khamsone Luck, Granger, IN (US)

Correspondence Address: Larry J. Palguta, Honeywell Law Department, 3520 Westmoor Street, South Bend, IN, 46628, US

(73) Assignee: Girish Shirhatti

(21) Appl. No.: 10/403,346

(22) Filed: Mar. 31, 2003

Related U.S. Application Data
(60) Provisional application No. 60/400,102, filed on Aug. 2, 2002.

(51) Int. Cl. G06F 17/60

(52) U.S. Cl. 705/28

(57) ABSTRACT

The present invention relates generally to systems and methods for managing inventory. A customer, through customer computer (102), and/or a user, through remote depot computer (104), may submit inventory information relating to wheel and brake assemblies to network server (108) and ultimately administrative server (110). This information may be used to update database (112). Inventory may be adjusted based, in-part, on the inventory information provided.

### RELATED APPLICATION DATA

This application is related to and claims priority to U.S. Provisional Application No. 60/400,102, filed Aug. 2, 2002, entitled “Systems and Methods for Inventory Management”, which is expressly incorporated herein by reference in its entirety.

### DESCRIPTION OF THE BACKGROUND OF THE INVENTION

1. Field of the Invention

This invention relates generally to managing inventory, and more specifically, to systems and methods for managing inventory based, in part, on information provided over a network.

2. Background of the Invention

Optimizing inventory for spare parts has always been a challenge for manufacturers of the spare parts. Storage space can be expensive and if the estimate for the amount of inventory required to ensure prompt turn around time is too high, the manufacturer must pay for storage space that is not necessary. However, if the estimate for the amount of inventory required is too low, it is possible that a part that a customer requests may not be available. This would result in the customer having to wait for a part, and thus, customer dissatisfaction.

Currently, the inventory in the system can be owned either by the manufacturer or by the customer, but the customer manages inventory at the customer end. The customer does not report inventory levels to the manufacturer. As such, the manufacturer is not aware of the customer's inventory. Based upon the fact that the manufacturer is unaware of the customer's future need, predicting what parts the customer may need may be difficult. As such, there is a need for a system that is capable of managing inventory such that excess inventory is reduced, storage space is optimized, and the turn-around time between the customer requesting a part and the customer receiving a part is optimized.

### SUMMARY OF THE INVENTION

In accordance with the principles consistent with the present invention, as embodied and broadly described herein, methods and systems consistent with the principles of the present invention provide for managing inventory. The methods and systems include maintaining location information of a plurality of parts at a first computer; receiving information relating to a change in the location information of one of the plurality of parts from at least one of a plurality of remote computers; updating the location information of the at least one of the plurality of parts at the first computer based on the information received, wherein information relating to location information may be accessed from the first computer indicating the exact location of each of the plurality of parts at any time.

Further principles consistent with the invention provide for systems and methods for providing information for managing inventory. The systems and methods include receiving a request to change a location of at least one of a plurality of parts; providing for the change of the location of at least one of a plurality of parts based on the request; obtaining current location information of at least one of a plurality of parts and storing the information on a remote logistic provider computer based on the request, wherein the current location information may relate to at least one of at least one customer site, at least one logistics provider site and at least one manufacture site; and sending the current location information of at least one of a plurality of parts to a first computer, wherein the first computer updates location information of the at least one of the plurality of parts at the first computer, and wherein information relating to current location information may be accessed from the first computer indicating the exact location of each of the plurality of parts at any time.

Additional features and aspects of the invention will be set forth in part in the description which follows, and in part will be obvious from the description, or may be learned by practice of the invention. The features and aspects of the invention will be realized and attained by means of the elements and combinations particularly pointed out in the appended claims.

### BRIEF DESCRIPTION OF THE DRAWINGS

The accompanying drawings, which are incorporated in and constitute a part of this specification, illustrate several embodiments of the invention and together with the description, serve to explain the principles of the invention, and, together with the description, explain the features and aspects of the invention. In the drawings,

FIG. 1 is an exemplary diagram of a system environment in which systems and methods, consistent with the principles of the present invention, may be implemented;

FIG. 2 is an exemplary diagram of the main components of a customer computer, consistent with the principles of the present invention;

FIG. 3 is an exemplary diagram of the main components of a network server, consistent with the principles of the present invention;

FIG. 4 depicts an exemplary diagram of the main components of an administrative server, consistent with the principles of the present invention;

FIG. 5 depicts an exemplary flow diagram of the steps performed by a customer computer consistent with the principles of the present invention;

FIG. 6 depicts an exemplary flow diagram of the steps performed by a network server consistent with the principles of the present invention;

FIG. 7 depicts an exemplary flow diagram of the steps performed by a remote depot computer, consistent with the principles of the present invention;

FIG. 8 depicts an exemplary image presented to a user when accessing a network server, consistent with the principles of the present invention;

FIG. 9 depicts an exemplary image presented to a user when accessing a network server for submitting information relating to removal and installation of units, consistent with the principles of the present invention;

FIG. 10 depicts an exemplary image presented to a user when accessing a network server for submitting information relating to transfer of serviceable units from one customer station to another, consistent with the principles of the present invention;

FIG. 11 depicts an exemplary image presented to a user when accessing a network server for submitting information relating to changing the status of a serviceable unit, consistent with the principles of the present invention;

FIG. 12 depicts an exemplary image presented to a user of a remote depot computer when accessing a network server, consistent with the principles of the present invention;

FIG. 13 depicts an exemplary image of a screen presented to a user of a remote depot computer for submitting information relating to the receipt of serviceable parts, consistent with the principles of the present invention;

FIG. 14 depicts an exemplary image of a screen presented to a user of a remote depot computer for submitting information relating to the shipment of serviceable parts, consistent with the principles of the present invention;

FIG. 15 depicts an exemplary image of a screen presented to a user of a remote depot computer for submitting information relating to the receipt of worn parts, consistent with the principles of the present invention;

FIG. 16 depicts an exemplary image of a screen presented to a user of a remote depot computer for submitting information relating to the shipment of worn parts, consistent with the principles of the present invention;

FIG. 17 depicts an exemplary flow diagram of the steps performed by an administrative server in managing inventory, consistent with the principles of the present invention; and

FIG. 18 depicts an exemplary diagram indicating the movement of parts, consistent with the principles of the present invention.

### DESCRIPTION OF THE EMBODIMENTS

Reference will now be made in detail to the present invention, examples of which are illustrated in the accompanying drawings. Wherever possible, the same reference numbers will be used throughout the drawings to refer to the same or like parts.

Overview

Methods and systems consistent with the principles of the present invention provide for allowing a customer, through a customer computer, and/or a user, through a remote depot computer, to access a network server through a network. The customer, through the customer computer, and/or a user, through a remote depot computer, may submit information to be stored on a database at an administrative server communicably linked to a network server. The information submitted by the customer and/or user may be used to update information contained in the database. Inventory may be adjusted based, in part, on the information provided by the user.

It may be appreciated by one of ordinary skill in the art, that many types of information may be utilized by the system as described herein. For exemplary purposes, the disclosure herein relates to inventory of parts for aircrafts, specifically, wheel and brake assemblies.

System Architecture

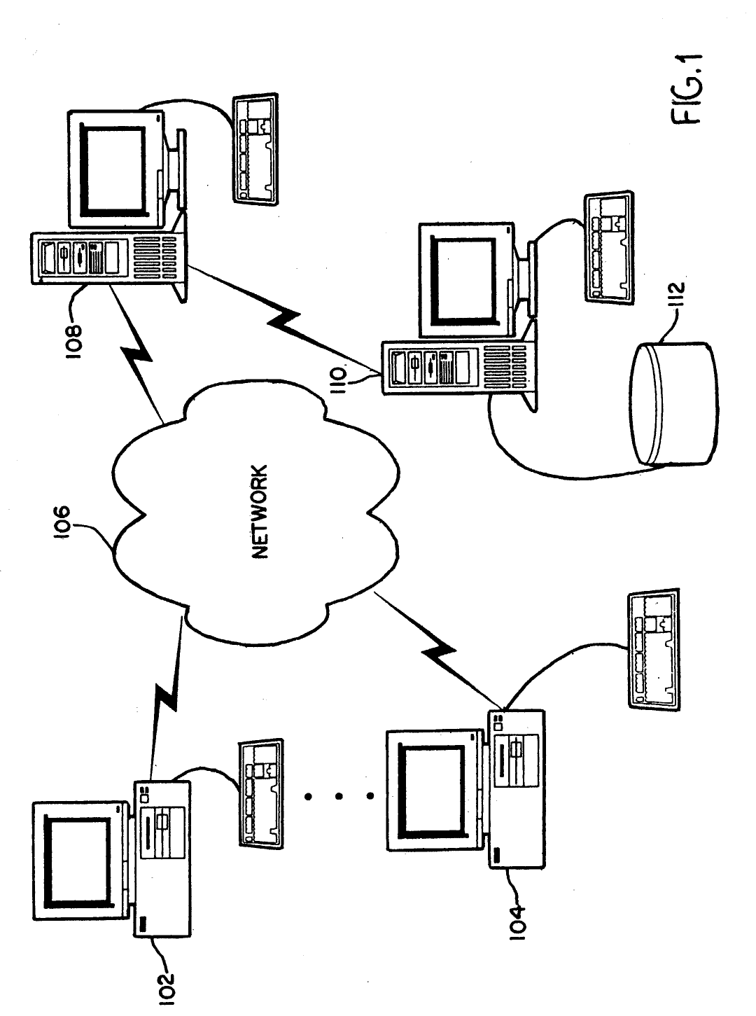

FIG. 1 is an exemplary diagram of a system environment 100 for implementing the principles of the present invention. The components of system 100 may be implemented through any suitable combinations of hardware, software, and/or firmware. As shown in FIG. 1, system 100 includes customer computer 102, remote depot computer 104, network 106, network server 108, administrative server 110 and database 112. It may be appreciated that any number of customer computers and remote depot computers may reside on network 106. Customer computer 102 and remote depot computer 104 may access network server 108 via network 108 through an associated Internet Service Provider (not shown). Customer computer 102 may represent a customer of the manufacturer, for example an airline maintaining aircrafts. Remote depot computer 104 may represent a third party provider that is responsible for maintaining inventory levels at remote depot, or remote warehouse locations.

Information submitted to network server 108 from customer computer 102 or remote depot computer 104 may be transmitted to administrative server 110 for updating and storing in database 112. While network 106 may preferably be implemented as the Internet, network 106 may be any local or wide area network, either public or private. Database 112 may be implemented as a conventional database application, for example, an Oracle® database. It may be appreciated that database 112 may reside at network server 108.

It can be appreciated by one of ordinary skill in the art that communication between remote depot computer 104 and network server 108 and/or administrative server 110 may be facilitated thought a network separate from network 106. It can further be appreciated by one of ordinary skill in the art that communication between customer computer 102 and network server 108 and/or administrative server 110 may be facilitated through a network separate from network 106.

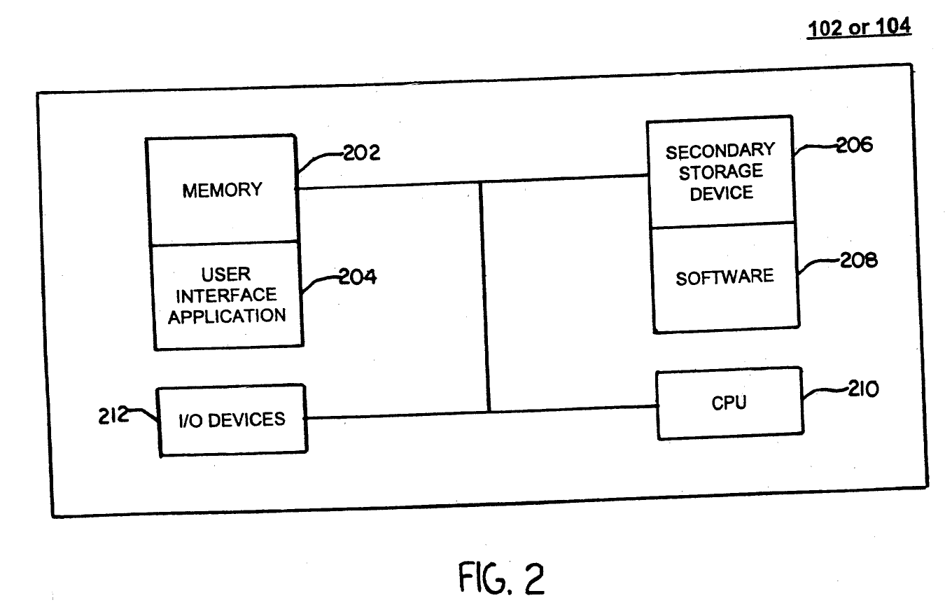

FIG. 2 depicts an exemplary block diagram of components contained in customer computer 102 and remote depot computer 104, consistent with the principles of the present invention. Customer computer 102 and remote depot computer 104 may be of any type of computing device, such as a personal computer or workstation, and may, for example, contain memory 202, browser software 204, secondary storage 206, software 208, central processing unit (CPU) 210 and input/output (I/O) devices 212. A customer or user may access network 106 using browser software 204. Browser 204 may comprise a conventional browser application, including conventional browser applications available from Microsoft or Netscape. Customer computer 102 and remote depot computer 104 may access network server 108 through network 106 through conventional methods including through an Internet connection, a virtual private network connection, etc. Additionally, it can be appreciated by one of ordinary skill in the art that security measures may be taken in the transmissions between customer computer 102, remote depot computer 104, network server 108, and administrative server 110, i.e., encryption of the data transmissions.

Input/output devices 212 may include, for example, a keyboard, a mouse, a video camera (for reading 2D data matrix tags), a display, a storage device, a printer, and/or any other device that may be communicably linked to the customer computer 102 or remote depot computer 104, for example, a personal digital assistant (PDA), which may include a wand for scanning, i.e., bar codes, a bar code reader, etc. User interface 204 may be implemented as a conventional browser application, including conventional browser applications available from Microsoft or Netscape. A user may launch user interface 204 through input/output devices 212 and access network server 108 through network 106. Software 208 may contain program instructions for assisting in communicating with the network server and further for assisting in formatting and transmitting inventory information relating to wheel and brake assemblies.

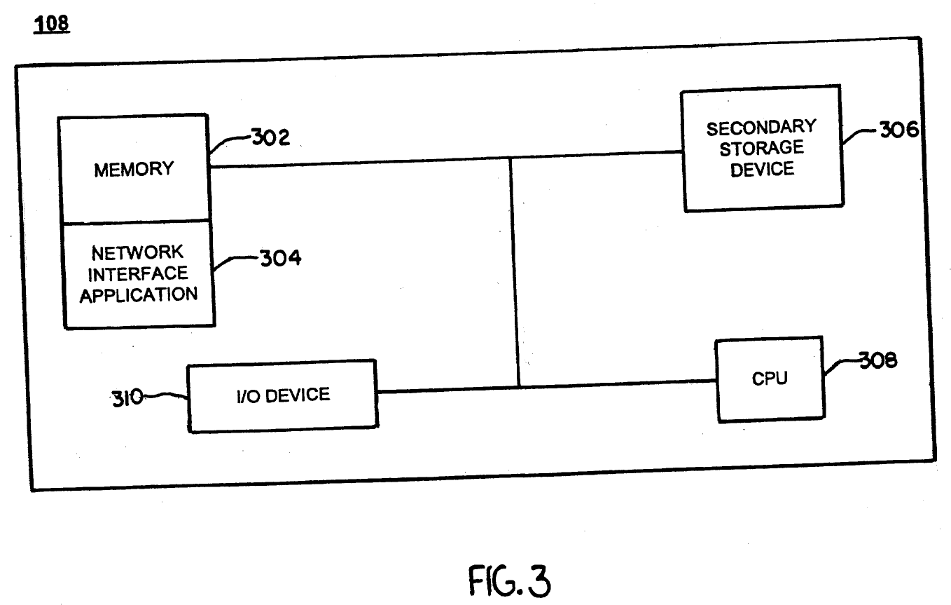

FIG. 3 depicts an exemplary diagram of network server 108 that may be implemented in system environment 100, consistent with the principles of the present invention. As shown in FIG. 3, network server 108 includes a memory 302, a network interface application 304, a secondary storage device 306, a CPU 308 and input/output devices 310. Input/output devices 212 may include, for example, a keyboard, a mouse, a video cam, a display, a storage device, and/or a printer. Network server 108 is connected to network 106 and may be communicably linked with customer computer 102 and remote depot computer 104 for accessing and submitting inventory information relating to brake and wheel assemblies through network interface application 304. Network server 108 may further be communicably linked to administrative server 110 wherein inventory information submitted from customer computer 102 and/or remote depot computer 104 may be transmitted to administrative server 110 for updating and storing in database 112.

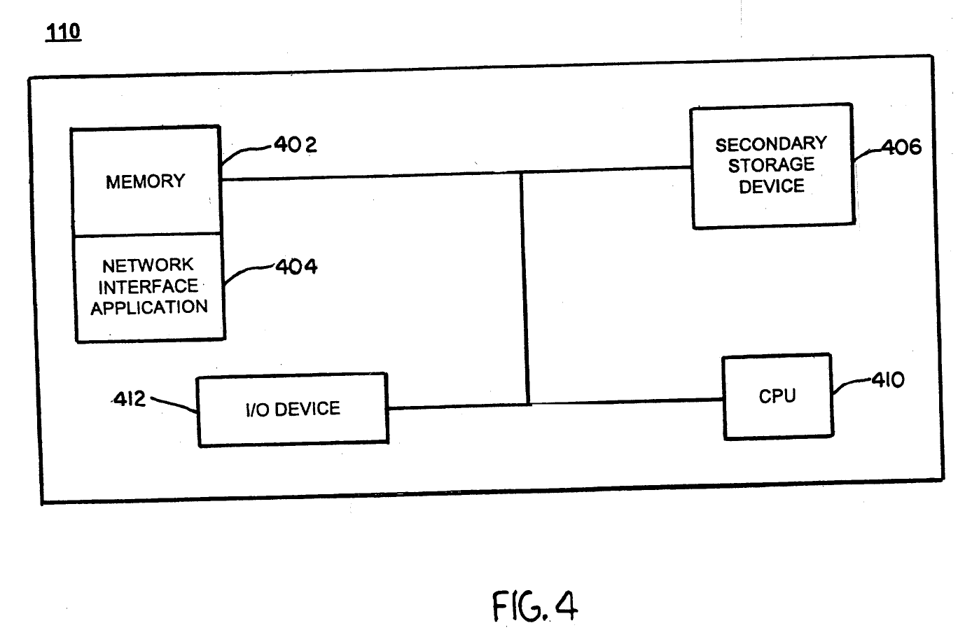

FIG. 4 depicts an exemplary diagram of administrative server 110 that may be implemented in system environment 100, consistent with the principles of the present invention. As shown in FIG. 4, administrative server 110 includes a memory 402, a secondary storage 406, a database 408, a CPU 410 and input/output devices 410. Administrative server 110 may be communicably linked to network server 108. It may be appreciated by one of ordinary skill in the art that the information contained in database 112 may be stored in secondary storage device 406 or secondary storage device 306.

Implementation

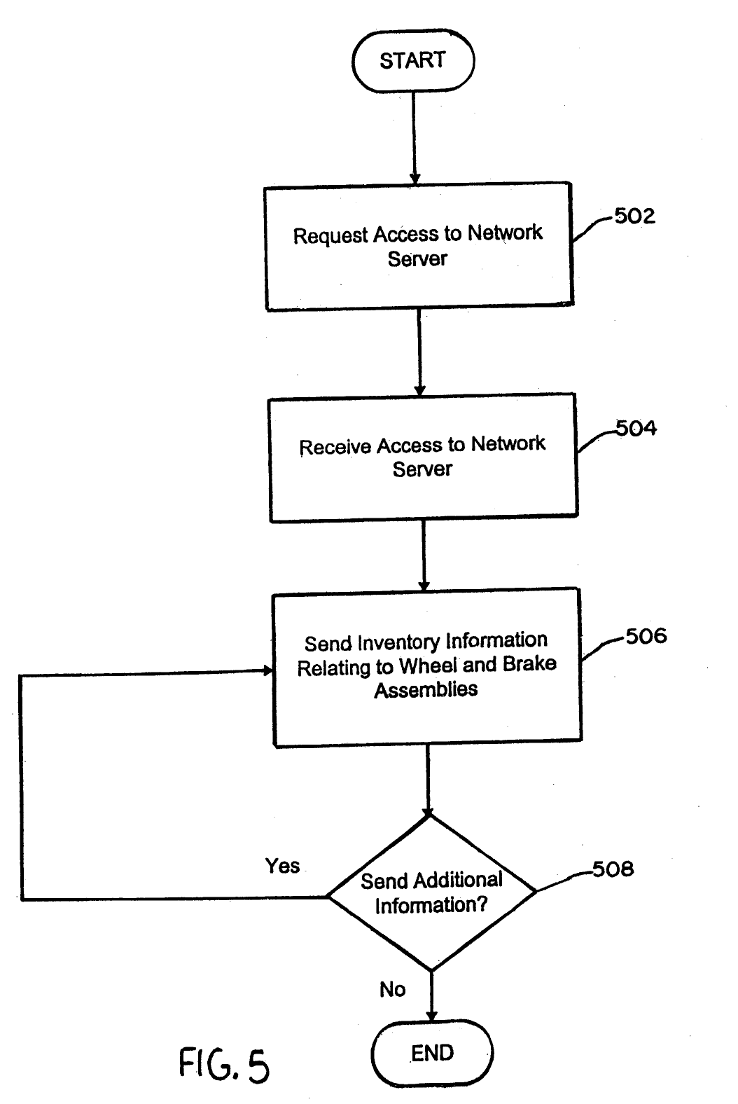

FIG. 5 depicts an exemplary flow chart of the steps performed by a customer computer 102 in accessing and submitting information to network server 108, consistent with the principles of the present invention. As shown in FIG. 5, customer computer 102, through user interface application 204, requests access to network server 108 through network 106 (Step 502). Upon the request for access to network computer 106, customer computer may be required to submit identifying and/or password information. Once customer computer 102 provides validating information, if required, access is granted to network server 108 (Step 504).

Customer computer 102 may then submit information relating to inventory of assembly parts including brakes and wheels for aircrafts (Step 506). Customer computer 102 may then receive an indication from network server 108 that the information was received. Customer computer 102 may then have the opportunity to provide additional information relating to inventory of assembly parts (Step 508). If customer computer 102 selects to provide additional information (Step 508, Yes), processing returns to Step 506. If no additional information is to be submitted by customer computer 102 (Step 508, No), then the connection to network server 108 is terminated and processing ends.

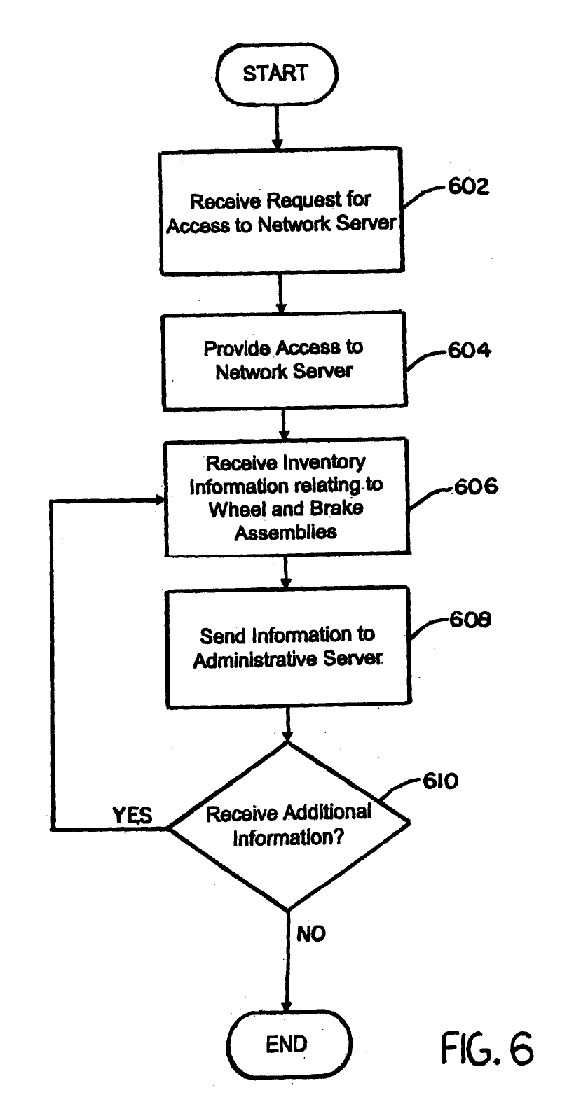

FIG. 6, depicts an exemplary flow chart of the steps performed by network server 108 in granting access to customer computer 102 and receiving information relating to inventory of assembly parts, consistent with the principles of the present invention. As shown in FIG. 6, network server 108 receives a request for access (Step 602). Network server 108 may request identifying information and/or a password. Based upon a validation of the identifying information and password, if required, access is granted to network server 108 (Step 604). Network server may then receive information relating to inventory of assembly parts (Step 606). The information received is then formatted as a record and submitted to administrative server 110 (Step 608). A determination is made as to whether additional information is to be received (Step 610). If additional information to be received (Step 610, Yes), then processing returns to Step 606. If no additional information is to be received (Step 610, No), then access to network server 108 is terminated and processing ends.

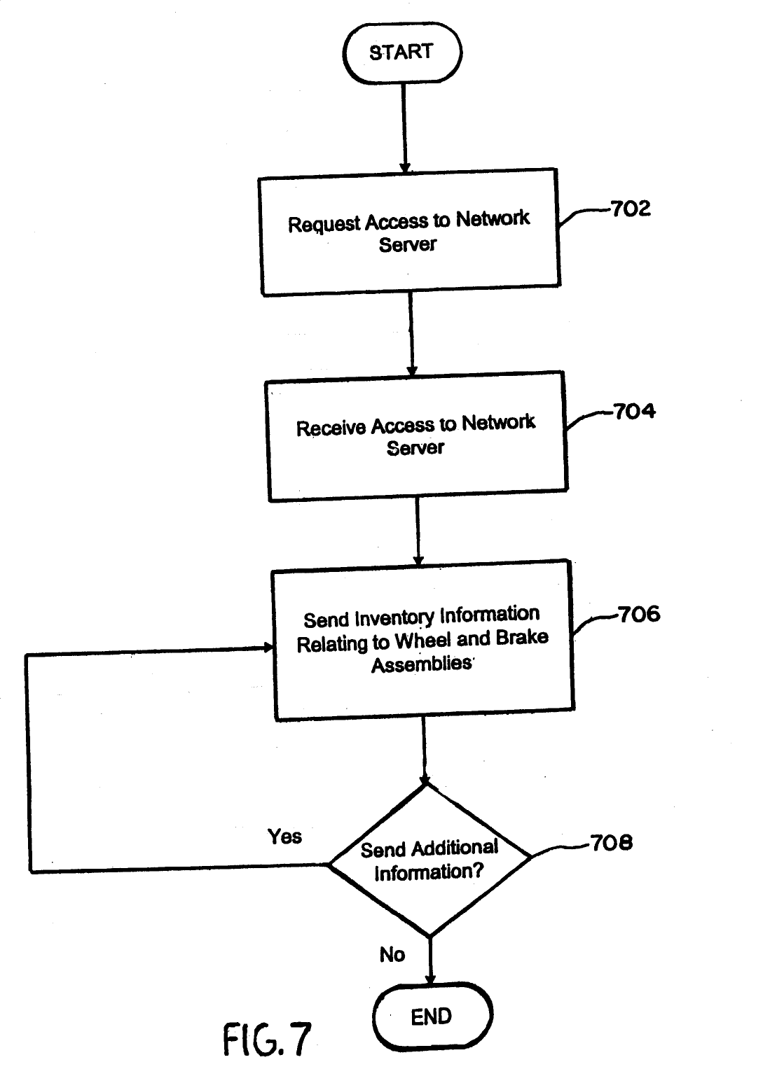

FIG. 7 depicts an exemplary flow chart of the steps performed by remote depot computer 104 in providing inventory information to network server 108, consistent with the principles of the present invention. As shown in FIG. 7, remote depot computer 104, through user interface application 204, requests access to network server 108 through network 106 (Step 702). Upon the request for access to network computer 106, remote depot computer 104 may be required to submit identifying and/or password information. Once remote depot computer 104 provides validating information, if required, access is granted to network server 108 (Step 704).

Remote depot computer 104 may then submit information relating to inventory of assembly parts including brakes and wheels for aircrafts (Step 706). Remote depot computer 104 may then receive an indication from network server 108 that the information was received.

Remote depot computer 104 may then have the opportunity to provide additional information relating to inventory of assembly parts (Step 708). If remote depot computer 104 selects to provide additional information (Step 708, Yes), processing returns to Step 706. If no additional information is to be submitted by remote depot computer 104 (Step 708, No), then the connection to network server 108 is terminated and processing ends.

Customer Computer Transactions

Removal and Installation

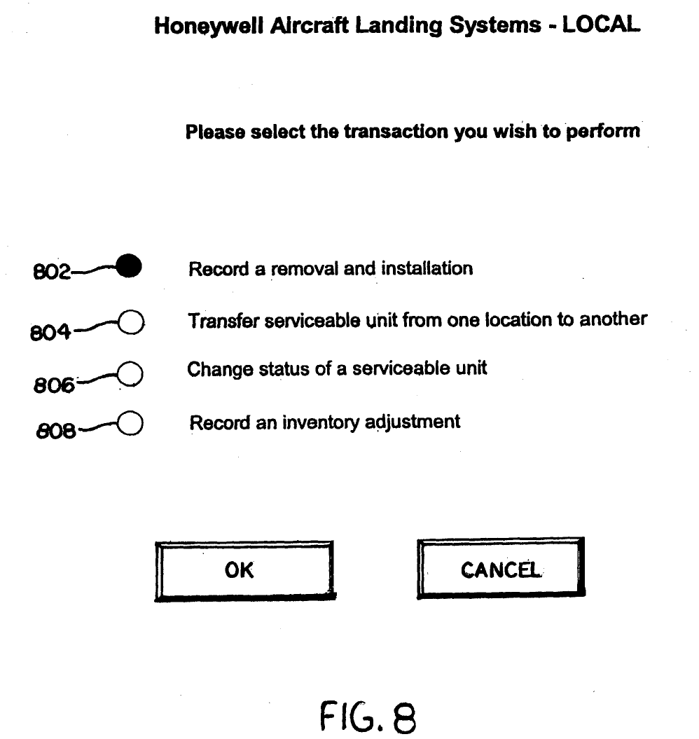

Any time a customer removes and replaces parts, transfers units from one location to another, wishes to change the status of a serviceable unit, or wishes to make an inventory adjustment, the customer submits information to administrative server 110 through network server 108. The process of the customer requesting access and providing information to the network server 108 is discussed above with regard to FIG. 5. Once information relating to the removal and replacement of the parts is sent to the administrative server, the information is submitted to database 112 (FIG. 1), the database is updated and inventory may be adjusted. FIG. 8 depicts an exemplary screen presented to the user in sending removal and replacement information to the administrative server, consistent with the principles of the present invention. As shown in FIG. 8, the customer may select between four options: record a removal and installation 802, transfer serviceable manufacturer's unit from one line station to another 804, change status of a serviceable unit 806 and record an inventory adjustment 808. In FIG. 8, the option for recording a removal and installation 802 is selected.

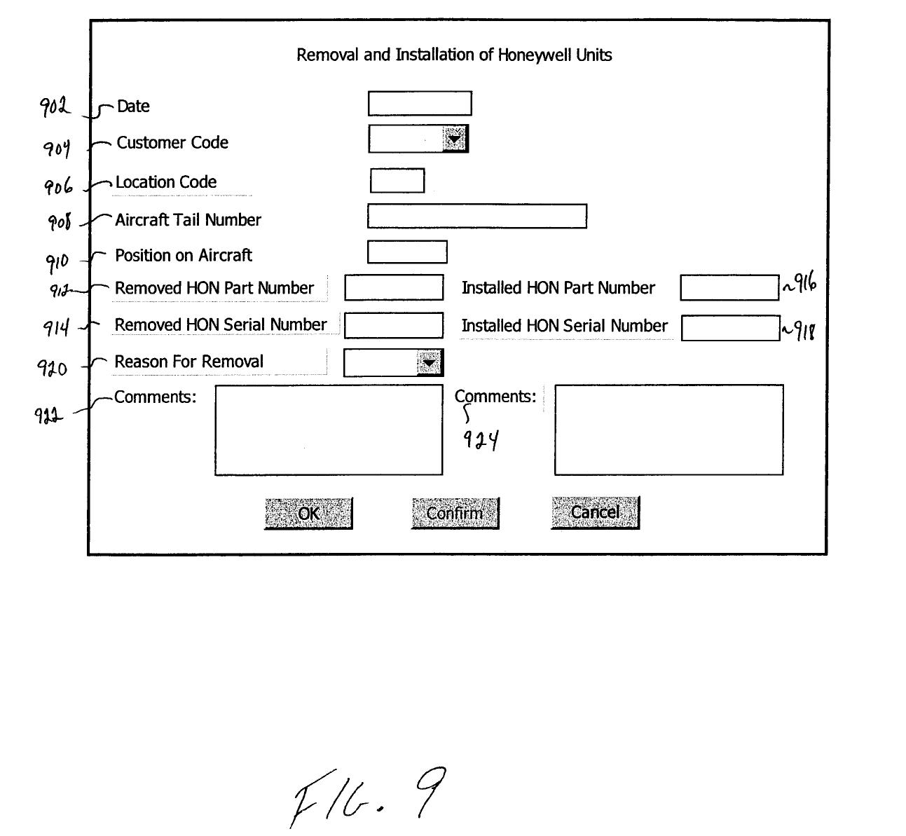

Once the customer selects the OK box, the exemplary screen depicted in FIG. 9 is presented to the customer. The customer, using input/output devices 212, completes the data fields provided. The date 902 may default to the current date for the convenience of the customer. The customer code 904 may be implemented as a character-based data field that is representative of the customer with the administrative server 110. This data field may be completed by the network server 108 based upon the customer's password provided when requesting access to the network server 108. Location code 906 may be implemented as a character-based data field representing the location of the customer. Aircraft tail number 908 may be implemented as an alphanumeric field that represents the tail number of the aircraft. Position on aircraft 910 may be implemented as an alpha-numeric field that represents the position on the plane where the part is being removed and replaced.

Removed HON part number 912 may be implemented as either a character-based or numeric-based data field and represents the part number that was removed from the aircraft. Removed HON Serial Number 914 may be implemented as either a character-based or numeric-based data field and represents the serial number of the part that was removed from the aircraft. Installed HON part number 916 may be implemented as either a character-based or numeric-based data field and represents the part number that was installed from the aircraft. Installed HON Serial Number 918 may be implemented as either a character-based or numeric-based data field and represents the serial number of the part that was installed from the aircraft. Reason for Removal 920 may be implemented as a drop-down menu and may contain multiple options for a customer to select. Comments 922 and 924 may be implemented as character-based data fields and allow a customer to include any comments regarding the removal and installation process. After the user has entered the information and selects the OK button, the information is sent to administrative server 110 as one record. This record is then sent to database 112 where the information is updated in the database.

Transfer of Serviceable Unit

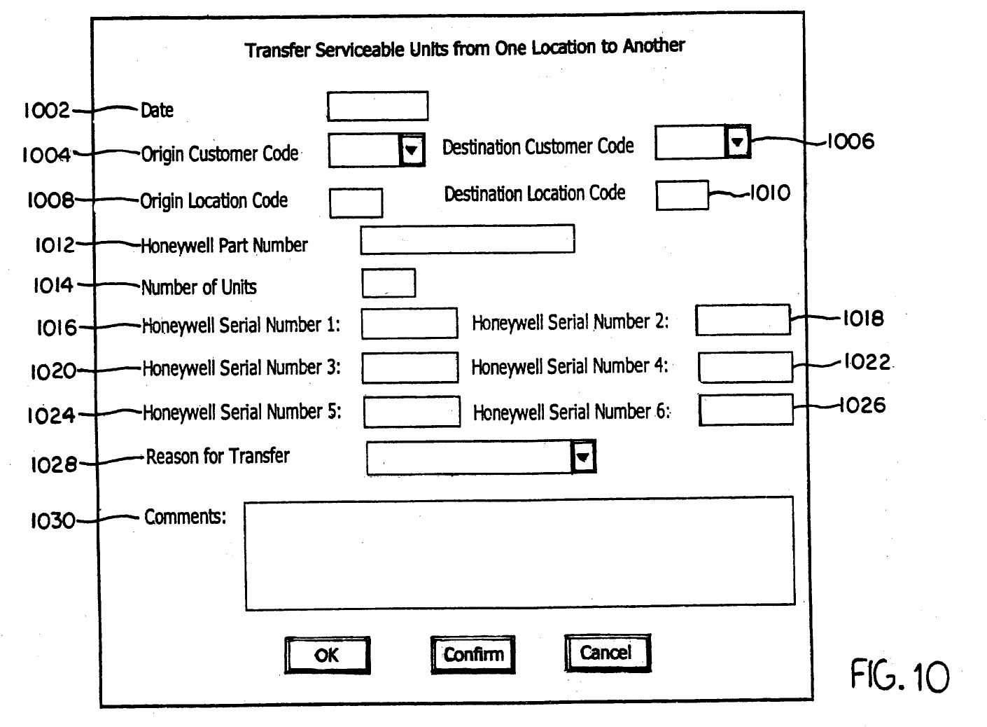

The second option a customer may select as shown in FIG. 8 is transfer serviceable manufacturer's unit from one customer station to another 804. This option may be utilized when a customer is transferring inventory from one location to another location. Upon selecting this option and selecting the OK button, the customer will be presented with a screen containing data fields to facilitate the transmission of the data. FIG. 10 depicts an exemplary screen image of a screen presented to a customer for submitting information relating to the transfer of serviceable units from one location to another. As shown in FIG. 10, the customer is prompted to enter the date. This data field may default to the current date for the convenience of the customer. Origin customer code 1004 may be implemented as a character-based data field and may represent an identification of the customer who is transferring the part. Destination customer code 1006 may be implemented as a character-based data field and may represent the identification code of the customer receiving the part. The system may complete this data field automatically once the origin customer code 1004 is completed for the convenience of the customer. However, the customer may modify this field if the part is being transferred to a different customer.

Origin location code 1008 may be implemented as a character-based data field and represents the origin location of the part to be transferred. Destination location code 1010 may be implemented as a character-based data field and may represent the destination location of the part being transferred. Manufacturer's part number may be implemented as a character-based or numeric-based field and represents the part number that is being transferred. Number of units 1014 may be implemented as a numeric-based field and represents the number of units to be transferred. Manufacturer's serial number 1016-1026 may be implemented dynamically. For example, the number entered in number of units 1014 may determine how many manufacturer's serial number data fields appear. Manufacturer's serial number 1016-1026 may be implemented as numeric-based fields and may represent the serial number of the parts to be transferred.

Reason for transfer 1028 may be implemented as a character-based field, or as a pull-down menu where the customer selects from a number of options representing the reason for transferring the units from one location to another. Comments 1030 may be implemented as a character-based field and may represent any additional comments the customer wishes to submit. Once the customer has entered the information in the screen, the customer may select the OK button. Network server 108 formats the information into a record and submits the information to administrative server 110. Administrative server 110 then updates the information in the database.

Change of Status of Serviceable Unit

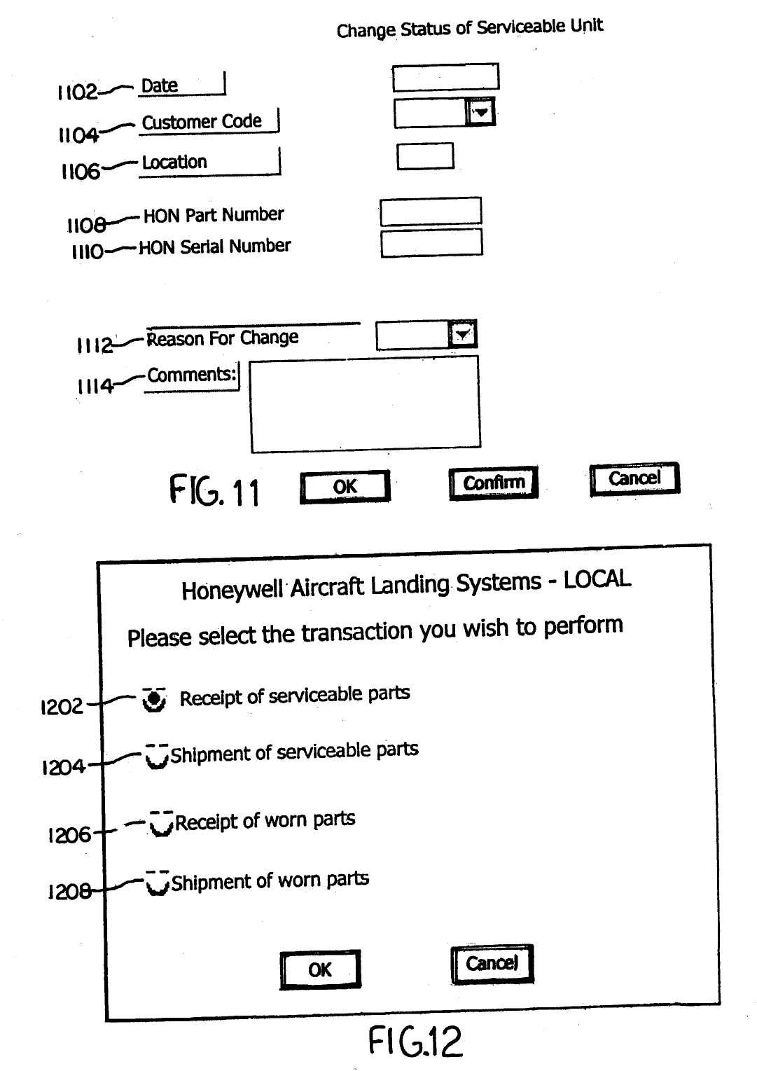

The third option a customer may select as shown in FIG. 8 is change the status of a serviceable unit 806. This may be done if a customer determines that a previously serviceable unit should not be used on an aircraft because of reasons such as obsolescence or spoilage due to accidents and that the unit should be repaired and/or overhauled. Upon selecting this option and selecting the OK button, the customer will be presented with a screen containing data fields to facilitate the transmission of the data. FIG. 11 depicts an exemplary screen image of a screen presented to a customer for submitting information relating to changing the status of a serviceable unit, consistent with the principles of the present invention. Data fields in FIG. 11 containing the same title to data fields discussed above are similarly implemented.

As shown in FIG. 11, the customer is prompted to enter date 1102, customer code 1104, location 1106, manufacturer's part number 1108, manufacturer's serial number 1110, and comments 1114. Additionally, the customer may provide reasons for change 1112. This data field may be implemented as a drop-down menu where the customer may selected from multiple options.

Once the customer has entered the information in the screen, the customer may select the OK button. Network server 108 formats the information into a record and submits the information to administrative server 110. Administrative server 110 then updates the information in the database.

Record an Inventory Adjustment

The final option a customer may select as shown in FIG. 8 is record an inventory adjustment 808. This may be done if a customer determines that an inventory adjustment should be made. Upon selecting this option and selecting the OK button, the customer will be presented with a screen containing data fields to facilitate transmission of the data. Data fields that may be included in this screen may include the customer code, the location code, the part number, the serial number, and the old location of the part and the new location of the part. Additionally, the customer may provide reasons for the adjustment.

Once the customer has entered the information in the screen, the customer may select an OK button. Network server 108 may then format the information into a record and submit the information to administrative server 110. Administrative server 110 may then update the information in the database. It may be appreciated that this information may also be updated through other means, including directly at the administrative server 110.

It can be appreciated by one of ordinary skill in the art that information that is entered by the customer through customer computer 102 may be used to update data at customer computer 102 in addition to updating data at administrative server 110 and/or network server 108. Remote Depot Computer Transactions

Users, through remote depot computers, may be responsible for maintaining inventory at remote depot locations and for tracking the movement of parts between customer locations, remote depot locations and administrative server locations.

While it may be appreciated that some of the features discussed above with regard to customer transactions may be performed by the remote depot computer 104, there are additional transactions that may be performed by the remote depot computer 104.

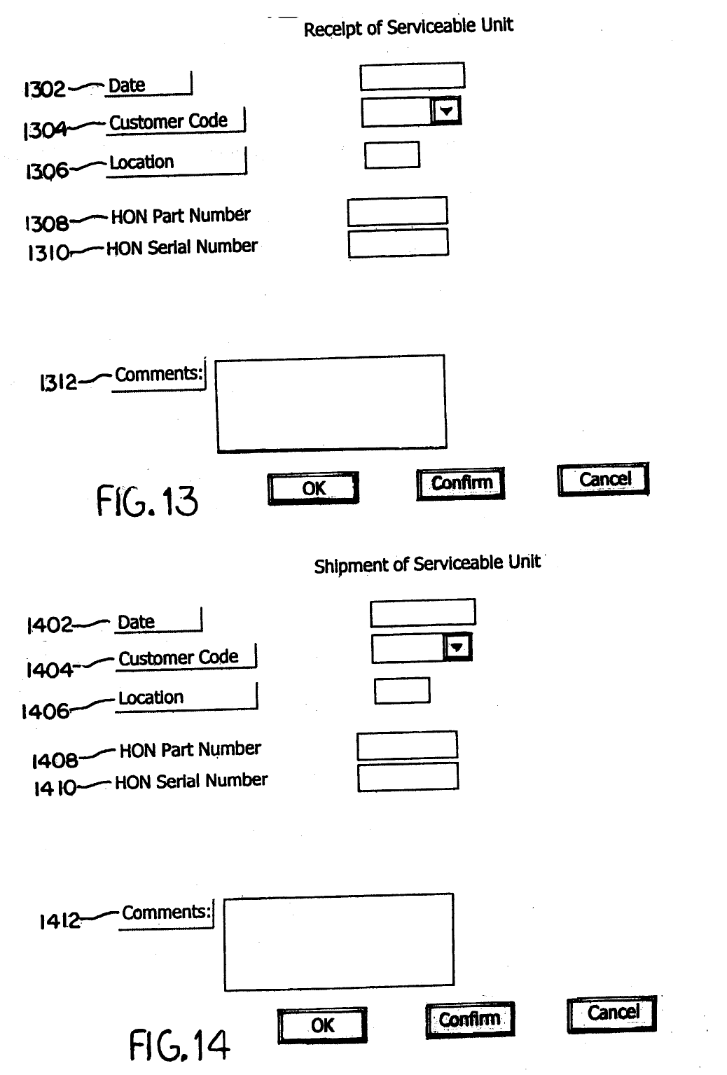

FIG. 12 depicts an exemplary screen image that is presented to a user of remote depot computer 104. The process of the user at a remote depot computer 104 requesting access and providing information to the network server 108 is discussed above with regard to FIG. 7. Once the inventory information relating to the wheel and brake assemblies is sent to administrative server 110 through network server 108, the information is submitted to database 112 (FIG. 1), the database is updated, and inventory may be adjusted. FIG. 12 depicts an exemplary screen presented to the user of a remote depot computer 104 for sending inventory information relating to wheel and brake assemblies to administrative server, consistent with the principles of the present invention. As shown in FIG. 12, the customer may select between four options: receipt of serviceable parts 1202, shipment of serviceable parts 1204, receipt of worn parts 1206, and shipment of worn parts 1208.

Receipt of Serviceable Parts

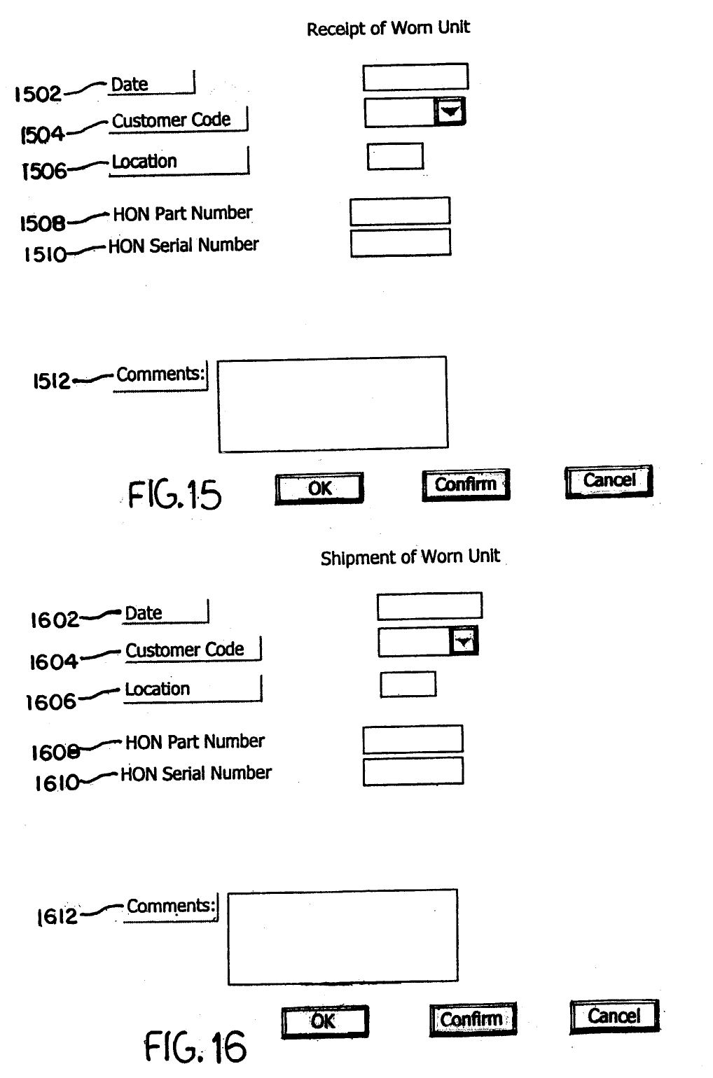

The first option a user at a remote depot computer 104 may select as shown in FIG. 12 is receipt of serviceable parts 1202. This transaction is performed when a user receives a serviceable part. Upon selecting this option and selecting the OK button, the user will be presented with a screen containing data fields to facilitate the transmission of the data. FIG. 13 depicts an exemplary screen image of a screen presented to a customer for submitting information relating to the receipt of serviceable parts, consistent with the principles of the present invention. Data fields in FIG. 13 containing the same title to data fields discussed above are similarly implemented.

As shown in FIG. 13, the user is prompted to enter date 1302, customer code 1304, location 1306, manufacturer's part number 1308, manufacturer's serial number 1310, and comments 1312. Other information that may be required includes date and time of reception, and data and time of recording the transaction. Once the information has been entered in the screen, the user may select the OK button. Network server 108 formats the information into a record and submits the information to administrative server 110. Administrative server 110 then updates the information in the database.

It can be appreciated by one of ordinary skill in the art that the customer, through customer computer 102 may have access to this option for providing information relating to receipt of serviceable parts.

Shipment of Serviceable Parts

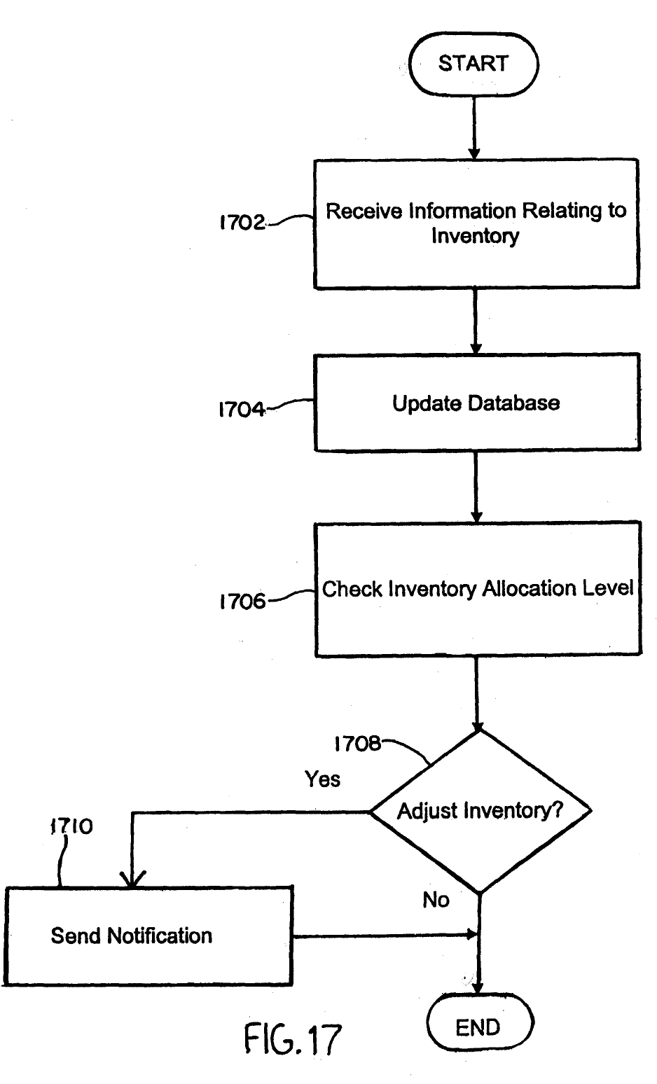

The second option for a user at a remote depot computer 104 is shipment of serviceable parts. This transaction is performed when a serviceable part is shipped from a remote depot location to a customer location. Upon selecting this option and selecting the OK button, the user will be presented with a screen containing data fields to facilitate the transmission of the data. FIG. 14 depicts an exemplary screen image of a screen presented to a customer for submitting information relating to the shipment of serviceable parts, consistent with the principles of the present invention. Data fields in FIG. 14 containing the same title to data fields discussed above are similarly implemented.

As shown in FIG. 14, the user is prompted to enter date 1402, customer code 1404, location 1406, manufacturer's part number 1408, manufacturer's serial number 1410, and comments 1412. Once the customer has entered the information in the screen, the customer may select the OK button. Network server 108 formats the information into a record and submits the information to administrative server 110. Administrative server 110 then updates the information in the database.

Receipt of Worn Parts

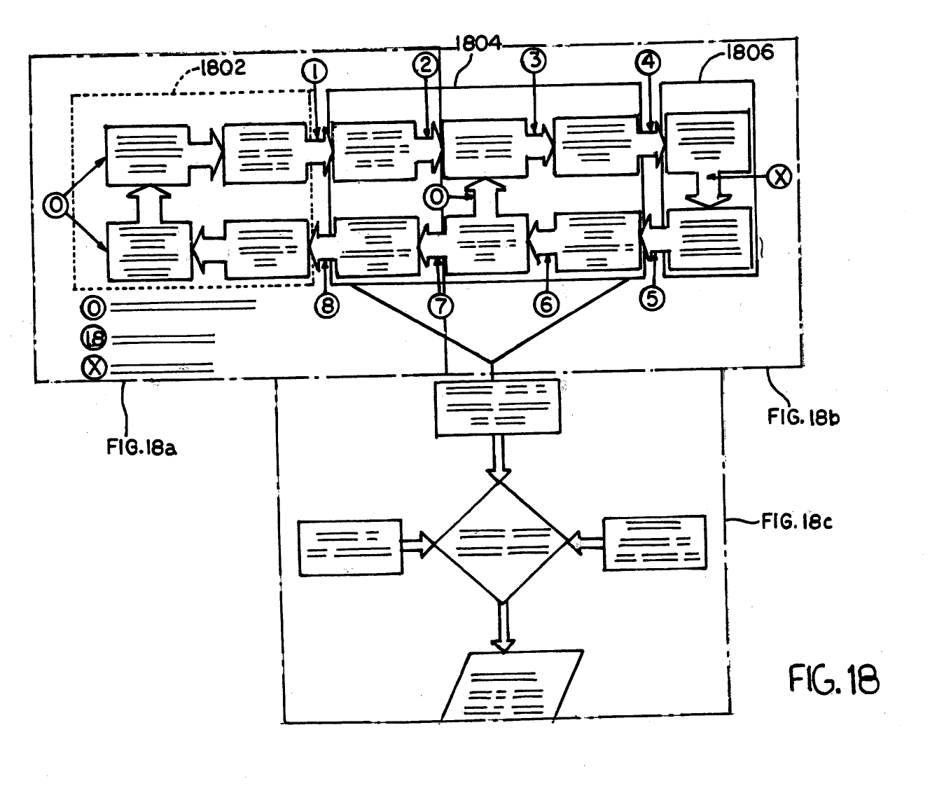

The third option for a user at a remote depot computer 104 is receipt of worn parts 1206. This transaction is performed when a worn part is received at a remote depot location from a customer location. Upon selecting this option and selecting the OK button, the user will be presented with a screen containing data fields to facilitate the transmission of the data. FIG. 15 depicts an exemplary screen image of a screen presented to a user for submitting information relating to the receipt of worn parts, consistent with the principles of the present invention. Data fields in FIG. 15 containing the same title to data fields discussed above are similarly implemented.

As shown in FIG. 15, the user is prompted to enter date 1502, customer code 1504, location 1506, manufacturer's part number 1508, manufacturer's serial number 1510, and comments 1512. Once the customer has entered the information in the screen, the customer may select the OK button. Network server 108 formats the information into a record and submits the information to administrative server 110. Administrative server 110 then updates the information in the database.

Shipment of Worn Parts

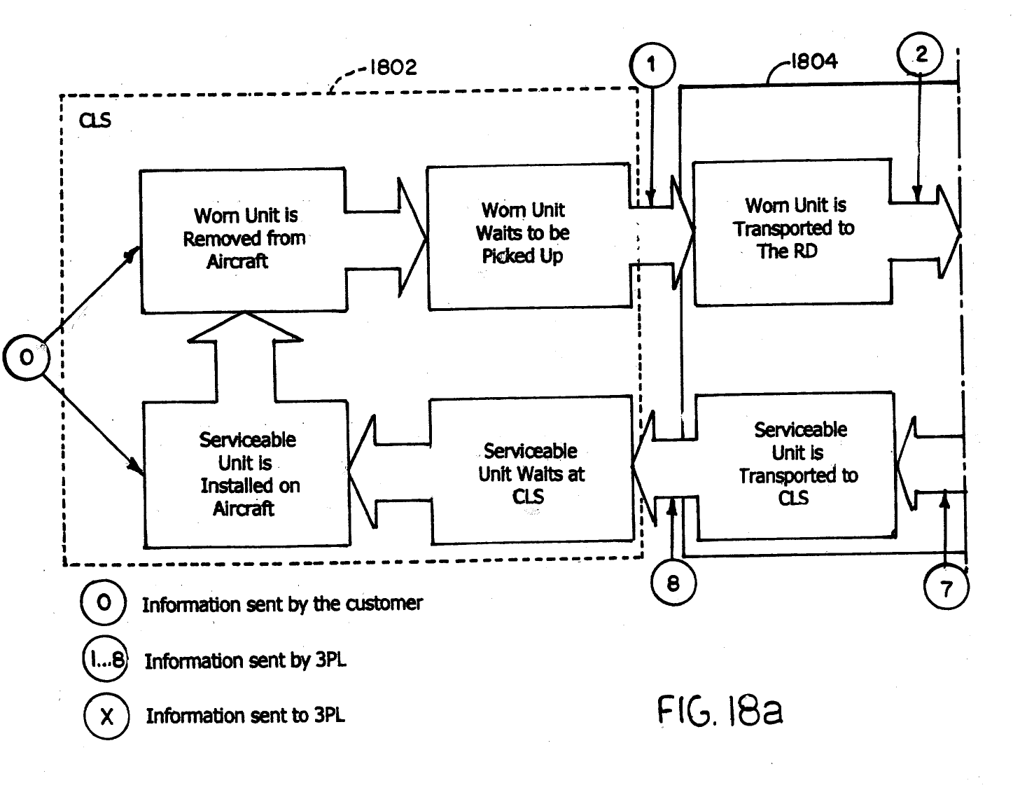

The fourth option for a user at a remote depot computer 104 is shipment of worn parts 1208. This transaction is performed when a worn part is shipped from a remote depot location to a customer location. Upon selecting this option and selecting the OK button, the user will be presented with a screen containing data fields to facilitate the transmission of the data. FIG. 16 depicts an exemplary screen image of a screen presented to a user for submitting information relating to the shipment of worn parts, consistent with the principles of the present invention. Data fields in FIG. 16 containing the same title to data fields discussed above are similarly implemented.

As shown in FIG. 16, the user is prompted to enter date 1602, customer code 1604, location 1606, manufacturer's part number 1608, manufacturer's serial number 1610, and comments 1612. Once the user has entered the information in the screen, the customer may select the OK button. Network server 108 formats the information into a record and submits the information to administrative server 110. Administrative server 110 then updates the information in the database.

It can be appreciated by one of ordinary skill in the art that the customer, through customer computer 102 may have access to this option for providing information relating to shipment of worn parts.

While the disclosure discussed above provides for the inventory information to be provided through the completion of data fields presented to a user at either a customer computer or a remote depot computer, it can be appreciated by one of ordinary skill in the art that the information may be provided to the system through an automatic process, which does not include the intervention of a user at a computer on the system.

It can be appreciated by one of ordinary skill in the art that information that is entered by the user through remote depot computer 104 may be used to update data at remote depot computer 104 in addition to updating data at administrative server 110 and/or network server 108.

Administrative Server

In addition to the information stored in database 112 discussed above, additional information is stored in database 112 to facilitate the maintenance and adjustment of inventory relating to wheel and brake assemblies. When information is received from either the customer computer or the remote depot computer, the inventory information may be updated in database 112 and, based upon this information, inventory may be adjusted. For example, if a customer has installed a serviceable part on an aircraft, additional inventory for that customer may need to be fulfilled at a remote depot location. As such, the following information is additionally stored in database 112.

Contractual allocation levels for customers by assembly number: data fields may be implemented as a customer code and an overall allocation, representing how many assembly units are to be allocated to the customer.

Individual customer allocation requirements: data fields may be implemented as a customer code, a location code, and an allocation with respect to the individual locations, representing how many assembly units are to be allocated to particular location of the customer.

Designations for all parts stored in the database: representing the status of the part, for example, worn, serviceable, ready to install, ready to be picked up, in-transit, and installed. One or more of these designations may be associated with a part.

Age of serviceable unit: a number representing how long the unit has been available for installation.

Processing transactions at the administrative server

After a transaction has been received from network server 108 at administrative server 110, the information may be updated in database 112. The following represent actions that are taken in updating database 112 based on transactions received from customer computer 102 and/or remote depot computer 104:

Removal and installation transaction: the part may be located in the database using the manufacturer's serial number. Once the information for the part is located, the designation of the part is changed from ready to install to installed.

Remove unit: the part may be located in the database using the manufacturer's serial number. Once the information for the part is located, the designation of the part is changed from installed to ready to be picked up.

Receive unit at customer location: the part may be located in the database using the manufacturer's serial number. Once the information for the part is located, the designation of the part is changed from in-transit to ready to install.

Ship unit from customer location: the part may be located in the database using the manufacturer's serial number. Once the information for the part is located, the designation of the part is changed from ready to be picked up to in-transit to remote depot location.

Receive serviceable unit at remote depot location: the part may be located in the database using the manufacturer's serial number. Once the information for the part is located, the designation of the part is changed from in-transit to remote depot location to ready to install.

Receive worn unit at remote depot location: the part may be located in the database using the manufacturer's serial number. Once the information for the part is located, the designation of the part is changed from in-transit to remote depot location to ready to be picked up.

Ship serviceable unit from remote depot location: the part may be located in the database using the manufacturer's serial number. Once the information for the part is located, the designation of the part is changed from ready to install to in-transit to remote depot or customer location.

Ship worn unit from remote depot location: the part may be located in the database using the manufacturer's serial number. Once the information for the part is located, the designation of the part is changed from ready to be picked up to repair and overhaul location.

Transfer serviceable unit between customer locations: the part may be located in the database using the manufacturer's serial number. Once the information for the part is located, the designation of the part is changed from ready to install to in transit to customer location.

Inventory Adjustment

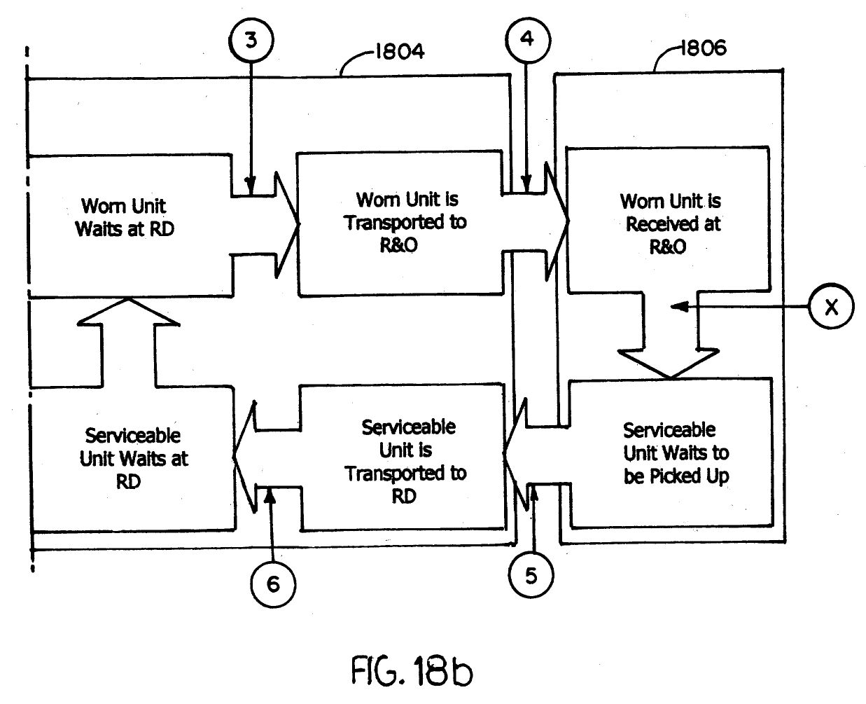

Inventory adjustments may be made based, in part on the inventory information provided by customer computer 102 and/or remote depot computer 104. For example, as noted above, allocation values are stored in database 112. These allocation values may be stored both for a customer as a whole, including all of the various locations a customer may have, and for the customer's various locations individually. Thus, after the inventory information that is provided by customer computer 102 and/or remote depot computer 104, it is possible that, for example, the inventory for a particular customer location may have dropped below the customer location allocation value. When this occurs, it is necessary that the inventory be adjusted. FIG. 17 depicts an exemplary flow diagram of the steps performed by the administrative server in maintaining inventory.

As shown in FIG. 17, administrative server 110 receives from network server 108 inventory information relating to wheel and brake assemblies (Step 1702). The information had previously been submitted to network server 108 from customer server 102 and/or remote depot server 104. Administrative server 110 updates the information in database 112 (Step 1704). The allocation levels are then compared with inventory levels contained in database 112 (Step 1706). Administrative server 110 makes a determination as to whether an inventory adjustment is necessary (Step 1708). An inventory adjustment to add parts to a particular location may be necessary if the inventory levels fall below the allocation levels for that particular location. Alternatively, if the inventory is above the allocation level for a particular location, thus resulting in storage of too many parts for a particular location, then an adjustment may be made to reduce the inventory at a particular location. If an adjustment to the inventory is necessary (Step 1708, Yes) the system sends notification to adjust the inventory accordingly (Step 1710). This notification may be submitted to a remote depot computer and/or customer computer through electronic mail. Alternatively, notification may be made to a user of the administrative server through electronic mail, through a report generated by the administrative server or through any other means known to one of ordinary skill in the art. If no adjustment is necessary (Step 1708, No), then processing ends.

Alternatively, inventory may be monitored through reports generated, for example, on a daily, weekly, or monthly basis, on demand, by designation of the parts including worn and serviceable inventory, representing the age of the serviceable units, etc. Alternatively, notifications may be generated if a serviceable unit is not used over a particular number of days.

In addition to reports, administrative server 110 may process individual inquiries regarding inventory information contained in database 112. For example, the following inquiries may be made:

Inventory position/individual stock levels per customer location: allows a user to request information regarding the total number of serviceable units per item including those that are ready to install, worn, ready to be picked up, serviceable units scheduled to be received, i.e., are in-transit.

Inventory position/Individual stock levels per remote depot location: allows a user to request information regarding the total number of serviceable units per item including those that are ready to install, worn, ready to be picked up, serviceable units scheduled to be received, i.e., are in-transit.

Contractual allocation levels per customer and/or customer location: allows a customer to request information regarding the contractual allocation levels per customer and/or customer location

Inventory position at customer location: allows a user to request information regarding a particular part or unit at a customer location

Inquiry by status: allows a user to request information based on the designation or status of the part, for example, ready to install, ready to be picked up, in-transit, installed on an aircraft, etc.

It can be appreciated that the system consistent with the principles of the present invention provide for an event triggering system. Events may be represented, for example, by a part or unit being moved from one position or location to another or an adjustment to inventory levels. An event may include, for example, a part being installed or removed from an aircraft, a part being transported from a customer location to a remote depot location, a remote depot location to an administrative location, an administrative location to a remote depot location, or a remote depot location to a customer location, a change to a contractual allocation level, etc. Once a computer on the system indicates one of the above events, this triggers another computer on the system to perform some task. The movements of parts within the system are described below.

Triggers and Alerts

It is possible for the system to generate a trigger and/or an alert when it is necessary for a person to take some physical action. For example, if the system determines, i.e., when running a report, that inventory levels have fallen below a particular level, the inventory should be replenished. Thus, the system may generate an alert to notify the appropriate person to replenish the inventory. In another example, information that may be stored within database 112 may relate to the shelf-life of parts. If the system determines, i.e., when running a report, that the shelf-life of a particular part has reached a certain threshold, then priority may be given to that part so that when a part of that type is needed, that particular part may be used before another part with a longer shelf-life. Further, if the shelf-life of a particular part has expired, a trigger or alert may be generated that notifies the appropriate person that the part should be sent out to be serviced.

Optimality of Parts Movement

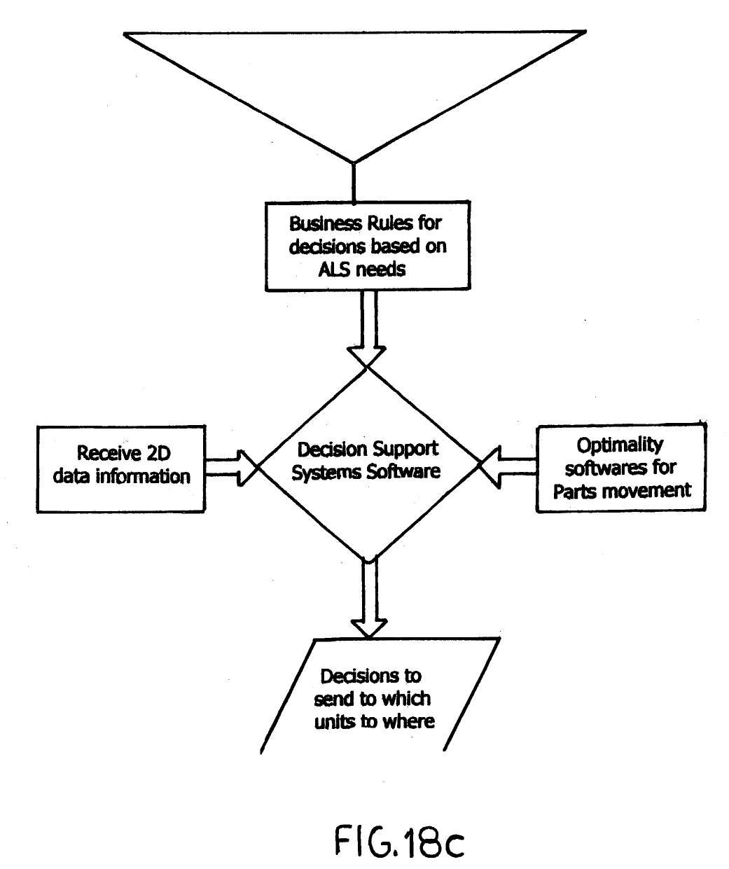

Given the capabilities set forth above regarding the customer computer 102, the remote depot computer 104, and the administrative server 110 accessing network 106 through network server 108, the present invention provides for optimizing the movement of parts. FIG. 18 sets forth a diagram that depicts the customer location 1802, the remote depot location 1804 and the administrative location 1806. Additionally, FIG. 18 depicts the flow of information and parts between these locations. As shown in FIG. 18, 0 may represent when the customer is sending information regarding a transaction. 1-8 represent when the remote depot is sending information regarding the status of a unit. X represents when information is being sent to the remote depot location.

Starting with the customer location 1802, a worn unit is removed from an aircraft and is waiting to be picked up. This information may be input into the system using the methods set forth above and a request for the pickup of the worn unit is sent to the remote depot computer. The remote depot computer/location 1804 receives the request, picks up the worn unit and transports the unit to the remote depot location. The worn unit waits at the remote depot location unit it is transported to the administrative location. At the administrative location 1806, the worn unit is repaired and/or overhauled. Once the unit is serviced, a request is sent to remote depot computer for the unit to be picked up and transferred back to the remote depot location.

The serviced unit is transported back to remote depot location 1804. The serviced unit may wait in inventory at the remote depot location until such time as it is required at a customer location. Once the unit is required at a customer location, i.e. to be installed on an aircraft directly, or to maintain inventory levels at a customer location, the serviced unit may be transported to the customer location 1802.

It may be appreciated by one of ordinary skill that the decisions made at reference points 1-8 may be made by software within the system. Factors that are considered in making these decisions may include at least one of input from software that optimizes the movement of parts through the system, the receipt of information relating to when a unit is installed and/or removed from an aircraft, and a variety of business rules. The information relating to when a unit is installed and/or removed from an aircraft may be in the form of a two dimensional barcode that is read or uploaded into the system and ultimately stored in database 112. The uploading process may be performed using, for example, Extensible markup Language (XML) tags and the data may be transmitted, for example, using a secure Virtual Private Network (VPN) client protocol.

The decisions made by the remote depot computer regarding the optimality of parts movement may be decided on at least one of the following:

Customer removal of a unit may be a trigger for a movement of a part

Allocation levels at the customer location may be determined based on contractual customer requirements.

Allocations levels at the remote depot location may be determined by a user at the remote depot location in order to fulfill on time delivery.

A customer location may be serviced by more than one remote depot location.

A user at a remote depot location may make a determination as to which remote depot location has the ability to service a customer location.

The administrative location and/or server may provide forecast inventory needs to allow the remote depot location(s) to plan inventory levels at the remote depot location(s).

The administrative server will supply the remote depot replenish cycle time from the administrative locations.

The administrative server will supply seasonal/cyclical part demand information to the remote depot computer.

The remote depot location will input current information into the system to determine which remote depot location is the optimal site to replenish the customer location.

It may further be appreciated that the diagram depicted in FIG. 18 does not include any transactions made between remote depot locations, between customer locations, or between administrative locations where parts may be serviced and/or overhauled. However, one of ordinary skill may appreciate, using the diagram depicted, how the information and the unit may be sent.

Self-Error Correction System

The system described herein, consistent with the principles of the present invention provide for correcting errors when receiving information at the administrative server 110 for storage in database 112. As described, for example, in FIG. 18, the system provides for a particular order of locations that the parts may move through when operating within the system. For example, a part cannot be installed on an aircraft at a customer location before it is transported to the customer location. As such, as the data is received at administrative server 110, an error check is performed to determine if the data transmission is received in proper order.

For example, a customer computer reports the removal of a unit from an aircraft. This transmission is received at the administrative server and the information is updated in database 112. The remote depot computer then reports that transportation of the unit to its remote depot location. This information is received at the administrative server and the information is updated in database 112. The administrative server then receives a transmission that the unit that was removed from the aircraft is waiting to be picked up at the customer location. Upon receiving this transmission, the administrative server notes that the transmission is out of sequence, since the unit has already been transported to the remote depot location. As such, this transmission is not current information. The administrative server may not store this information in the database as current information. Thus, the error of receiving the transmission out of sequence is corrected.

Performance Measurement

Given the amount and type of data that is being stored in the present system, the data may be manipulated in order to measure performance.

The administrative server may access to the data in order to evaluate performance within the system. Additionally, customers may access the data in order to evaluate performance within the system, i.e., how the system is complying with contractual obligations. Further, remote depot locations may access the, data in order to evaluate performance within the system. Performance may be measured or evaluated in a variety of ways, including inventory levels, turn-around-time, delivery metrics, order management, transportation management, reverse logistics, returned goods, customer support services, productivity, etc.

Customers, remote depot locations, and users of the administrative server may access the data to determine how often their personnel move their parts between airports generating inefficiencies between customer locations. Additionally, by analyzing information relating to the standard lifetime of a part and how often the part was replaced, the customer may analyze how skillfully their pilots are operating the aircraft, i.e., if a tire or brake in a particular position always wears out faster than others, etc. Additionally, the customer may be able to analyze the data to determine, based upon the data, inventory allocations may need to be adjusted.

These performance measurements may be calculated using conventional forecasting and trend analysis software.

Prediction of Unit Arrival

It can be appreciated the ability to predict when unit inventory will arrive is helpful. Generally, it is difficult to predict what is being transported to a particular location, which leads to inefficiencies in performance in addition to excess inventory. However, in the system consistent with the principles of the present invention, this information is visible to all computers on the system. For example, at any point in real time, the customer computer can access the data in database 112 to determine what inventory levels are at a particular location, what units are in transit to what locations, when units will arrive to a customer location, etc. Having this information may improve performance at the customer location as, among other things, managers can plan work schedules in advance, maybe planning overtime, they can plan the transportation of units more efficiently, thus reducing the cost of expedited services, etc.

Data Warehouse

It can be appreciated that in addition to database 112, additional databases may reside on network 106. For example, an additional database may reside on network 106 that includes a data warehouse for storing historic data that is no longer current information. By providing for this additional warehouse database, database 112 may contain only updated information providing faster access by the customer computer and the remote depot computer.

It can be appreciated by one of ordinary skill that both the customer computer and the remote depot computer may access information contained in the warehouse computer in order to measure performance as discussed above and further to generate reports as discussed below.

Reports

Reports may be generated using the information contained in database 112. For example, reports can be generated to show inventories for each assembly part number at each customer location, the comparison of inventory of serviceable units to allocation levels, inventory levels, mail notifications, inventory levels that fall below allocation levels, a summary with data on the average and maximum number of worn units at customer locations, serviceable and worn inventory at remote depot locations, aging reports of serviceable units, mail notifications if serviceable units are not used within a specified number of days, etc.

Additionally, the following reports may be generated:

Performance reports may be generated that provide information relating to the performance as discussed above.

On time delivery reports may be generated that provide information relating to whether parts are delivered to particular locations on time. These reports may be accessed, for example, by the customer computer, the remote depot computer, etc.

Ability to meet seasonal airline demands reports may be generated that provide information regarding whether the remote depot locations are meeting the demands of customers. These reports may be accessed, for example, by the remote depot computer.

Ability to meet percentage of allocation reports may be generated that provide information regarding whether the remote depot locations are able to maintain allocation levels as provided for in the system. These reports may be accessed, for example, by the remote depot computers.

Distribution cost per unit reports may be generated that provide information relating to the distribution cost per unit. These reports may be accessed, for example, by the remote depot computer.

Cycle time reports may be generated that provide information relating to the cycle time of a part in the system. These reports may be accessed, for example, by the customer computer and the remote depot computer.

Pickup metric reports may be generated that provide information relating to the pickup of parts at the various locations. These reports may be accessed, for example, by the customer computer and the remote depot computer.

Customer replenish metric reports may be generated that provide information relating to the replenishment of parts at the customer locations. These reports may be accessed, for example, by the customer computer and the remote depot computer.

Forecast of assembly report by serial number or aircraft reports may be generated that provide information regarding the forecasting of assemblies. These reports may be generated by, for example, serial number or aircraft. These reports may be accessed, for example, by the customer computer.

Accuracy of recorded tail number information reports may be generated that provide information regarding the accuracy of information regarding a recorded aircraft tail number.

Forecast of remote depot demand reports may be generated that forecast the demand of inventory at a remote depot location.

Inventory reconciliation reports that reconcile inventory may be run.

It can be appreciated by one of ordinary skill in the art that various other types of reports may be run that access and manipulate information contained in database 112. It can further be appreciated that the reports mentioned above may be accessed in a number of ways, namely, directly accessed by a computer on the network, automatically generated by network server 108 and/or administrative server 110 and sent to a computer on the network via, for example, e-mail, etc.

### CONCLUSION

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or hardware alone.

Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

What is claimed is:

1. A method for managing inventory comprising:
maintaining location information of a plurality of parts at a first computer;
receiving information relating to a change in the location information of one of the plurality of parts from at least one of a plurality of remote computers;
updating the location information of the at least one of the plurality of parts at the first computer based on the information received, wherein information relating to location information may be accessed from the first computer indicating the exact location of each of the plurality of parts at any time.

2. The method of claim 1, wherein the plurality of remote computers includes at least one remote customer computer located at at least one customer site and at least one remote logistics provider computer located at at least one logistics provider site.

3. The method of claim 2, wherein the method further includes: maintaining information relating to minimum inventory levels required for at least one of the at least one customer site and the at least one logistics provider site; determining if the updated location information results in the number of parts at one of the at least one customer site and at least one logistics provider site falling below the minimum inventory level; and sending a notification requesting additional inventory be supplied to at least one of the at least one customer site and the at least one logistics provider site.

4. The method of claim 3, wherein additional inventory is optimally supplied.

5. The method of claim 3, wherein delivery information may be predicted based at least upon maintained location information.

6. The method of claim 2, wherein the method further includes:
maintaining information at the first computer relating to the life expectancy of each of the parts;
updating the information relating to the life expectancy of each of the parts based on the updated location information received from each of the plurality of remote computers;
determining that the life expectancy of at least one of the parts has been exceeded; and
sending a notification requesting that the part be replaced based on the determination.

7. The method of claim 1, wherein the location information includes a plurality of locations including at least one of a location on a plane, a location at a customer site, a location at a logistics provider site, an in-transit location, and a location at a manufacture's site.

8. The method of claim 1, wherein updating the information further includes:
determining an order of locations for each of a plurality of parts;
determining if the received information from relating to the change in location of one of the plurality of parts corresponds to the order of locations for the one of the plurality of parts;
updating the information if the received information corresponds to the order of locations; and
maintaining the current information relating to the location of the one of the plurality of parts if the received information does not correspond to the order of locations for the one of the plurality of parts.

9. The method of claim 1, further including generating at least one report utilizing the maintained location information.

10. The method of claim 1, further including utilizing the maintained location information to measure performance.

11. A method for providing information for managing inventory comprising:
receiving a request to change a location of at least one of a plurality of parts;
providing for the change of the location of at least one of a plurality of parts based on the request;
obtaining current location information of at least one of a plurality of parts and storing the information on a remote logistic provider computer based on the request,
wherein the current location information may relate to at least one of at least one customer site, at least one logistics provider site and at least one manufacture site; and
sending the current location information of at least one of a plurality of parts to a first computer,
wherein the first computer updates location information of the at least one of the plurality of parts at the first computer, and
wherein information relating to current location information may be accessed from the first computer indicating the exact location of each of the plurality of parts at any time.

12. A computer-readable medium containing instructions for causing a processor to perform a method for managing inventory comprising:
maintaining location information of a plurality of parts at a first computer;
receiving information relating to a change in the location information of one of the plurality of parts from at least one of a plurality of remote computers;
updating the location information of the at least one of the plurality of parts at the first computer based on the information received, wherein information relating to location information may be accessed from the first computer indicating the exact location of each of the plurality of parts at any time.

13. The computer-readable medium of claim 12, wherein the plurality of remote computers includes at least one remote customer computer located at at least one customer site and at least one remote logistics provider computer located at at least one logistics provider site.

14. The computer-readable medium of claim 13, wherein the method further includes:
maintaining information relating to minimum inventory levels required for at least one of the at least one customer site and the at least one logistics provider site;
determining if the updated location information results in the number of parts at one of the at least one customer site and at least one logistics provider site falling below the minimum inventory level; and
sending a notification requesting additional inventory be supplied to at least one of the at least one customer site and the at least one logistics provider site.

15. The computer-readable medium of claim 14, wherein additional inventory is optimally supplied.

16. The computer-readable medium of claim 14, wherein delivery information may be predicted based at least upon maintained location information.

17. The computer-readable medium of claim 12, wherein the method further includes:
maintaining information at the first computer relating to the life
expectancy of each of the parts;
updating the information relating to the life expectancy of each of the parts based on the updated location information received from each of the plurality of remote computers;
determining that the life expectancy of at least one of the parts has been exceeded; and
sending a notification requesting that the part be replaced based on the determination.

18. The computer-readable medium of claim 12, wherein the location information includes a plurality of locations including a location on a plane, a location at a customer site, a location at a logistics provider site, and a location at a manufacture's site.

19. The computer-readable medium of claim 12, wherein updating the information further includes:
determining an order of locations for each of a plurality of parts;
determining if the received information from relating to the change in location of one of the plurality of parts corresponds to the order of locations for the one of the plurality of parts;
updating the information if the received information corresponds to the order of locations; and
maintaining the current information relating to the location of the one of the plurality of parts if the received information does not correspond to the order of locations for the one of the plurality of parts.

20. The computer-readable medium of claim 12, further including generating at least one report utilizing the maintained location information.

21. The computer-readable medium of claim 12, further including utilizing the maintained location information to measure performance.

22. A computer-readable medium containing instructions for causing a processor to perform a method for providing information for managing inventory comprising:
receiving a request to change a location of at least one of a plurality of parts;
providing for the change of the location of at least one of a plurality of parts based on the request;
obtaining current location information of at least one of a plurality of parts and storing the information on a remote logistic provider computer based on the request,
wherein the current location information may relate to at least one of at least one customer site, at least one logistics provider site and at least one manufacture site; and
sending the current location information of at least one of a plurality of parts to a first computer,
wherein the first computer updates location information of the at least one of the plurality of parts at the first computer, and wherein information relating to current location information may be accessed from the first computer indicating the exact location of each of the plurality of parts at any time.

23. An apparatus for managing inventory comprising:
a memory storing program instructions;
a processor configured to respond to the program instructions to maintain location information of a plurality of parts at a first computer;
receive information relating to a change in the location information of one of the plurality of parts from at least one of a plurality of remote computers;
update the location information of the at least one of the plurality of parts at the first computer based on the information received,
wherein information relating to location information may be accessed from the first computer indicating the exact location of each of the plurality of parts at any time.

24. The apparatus of claim 23, wherein the plurality of remote computers includes at least one remote customer computer located at at least one customer site and at least one remote logistics provider computer located at at least one logistics provider site.

25. The apparatus of claim 24, the processor is further configured to:
maintain information relating to minimum inventory levels required for at least one of the at least one customer site and the at least one logistics provider site;
determine if the updated location information results in the number of parts at one of the at least one customer site and at least one logistics provider site falling below the minimum inventory level; and
send a notification requesting additional inventory be supplied to at least one of the at least one customer site and the at least one logistics provider site.

26. The apparatus of claim 25, wherein additional inventory is optimally supplied.

27. The apparatus of claim 25, wherein delivery information may be predicted based at least upon maintained location information.

28. The apparatus of claim 24, wherein the processor is further configured to:
maintain information at the first computer relating to the life expectancy of each of the parts;
update the information relating to the life expectancy of each of the parts based on the updated location information received from each of the plurality of remote computers;
determine that the life expectancy of at least one of the parts has been exceeded; and
send a notification requesting that the part be replaced based on the determination.

29. The apparatus of claim 23, wherein the location information includes a plurality of locations including location on a plane, a location at a customer site, a location at a logistics provider site, and a location at a manufacture's site.

30. The apparatus of claim 23, wherein when the processor updates the information the processor is further configured to:
determine an order of locations for each of a plurality of parts;
determine if the received information from relating to the change in location of one of the plurality of parts corresponds to the order of locations for the one of the plurality of parts;
update the information if the received information corresponds to the order of locations; and
maintain the current information relating to the location of the one of the plurality of parts if the received information does not correspond to the order of locations for the one of the plurality of parts.

31. The apparatus of claim 23, wherein the processor is further configured to generate at least one report utilizing the maintained location information.

32. The apparatus of claim 23, wherein the processor is further configured to utilize the maintained location information to measure performance.

33. An apparatus for providing information for managing inventory comprising:
a memory storing program instructions;
a processor configured to respond to the program instructions to receive a request to change a location of at least one of a plurality of parts;
provide for the change of the location of at least one of a plurality of parts based on the request;
obtain current location information of at least one of a plurality of parts and storing the information on a remote logistic provider computer based on the request,
wherein the current location information may relate to at least one of at least one customer site, at least one logistics provider site and at least one manufacture site; and
send the current location information of at least one of a plurality of parts to a first computer,
wherein the first computer updates location information of the at least one of the plurality of parts at the first computer, and
wherein information relating to current location information may be accessed from the first computer indicating the exact location of each of the plurality of parts at any time.
